(19) United States
(12) Patent Application Publication
(10) Pub. No.: US 2015/0224420 A1
(43) Pub. Date: Aug. 13, 2015

(54) PROCESSES FOR THE PRODUCTION OF PLURAL ANHYDROUS ALCOHOLS

(71) Applicant: Robert Hickey, Okemos, MI (US)

(72) Inventor: Robert Hickey, Okemos, MI (US)

(21) Appl. No.: 14/176,021

(22) Filed: Feb. 7, 2014

(51) Int. Cl. B01D 3/00; B01D 53/26; B01D 3/14

(52) U.S. Cl. CPC B01D 3/002; B01D 3/145; B01D 3/143; B01D 53/261; B01D 53/268

(57) ABSTRACT

Improved processes are disclosed for obtaining discrete ethanol and at least one discrete product containing a higher boiling alcohol from an aqueous fermentation broth. In the processes a vaporous, azeotropic mixture is obtained from the fermentation broth through fractionation by distillation and is maintained at a temperature sufficient to effect dehydration without condensation of ethanol and the at least one higher alcohol. The dehydrated mixture of alcohols is further fractionated by distillation to provide a dehydrated, ethanol-rich product and a dehydrated, higher alcohol-rich product.

### FIELD OF THE INVENTION

This invention pertains to processes for recovering ethanol and at least one higher alcohol from fermentation broths.

### BACKGROUND

Fermentation processes to produce oxygenated organic compounds, including, but not limited to ethanol and butanol, are well known and have found commercial application. One means for recovering the oxygenated organic compound from the fermentation broth has been fractionation by distillation. A number of the oxygenated organic compounds, including, but not limited to C₂+alcohols from azeotropes with water and with some combinations of oxygenated organic compounds can form ternary azeotropes, e.g., water:ethanol:ethyl acetate.

Unit operations to recover an oxygenated organic compound forming an azeotrope with water have been developed. Commodity oxygenated organic compounds such as ethanol have intricate, integrated unit operations for fractional distillation and dehydration of the azeotrope. See, for instance, U.S. Pat. Nos. 7,297,236 B1 and 7,699,961. Other processes have used membrane separation as a unit operation to separate ethanol or butanol from water. See, for instance, U.S. Pat. No. 8,211,679 B2. One conventional process for recovering n-butanol involves introducing an aqueous feed containing about 40 percent n-butanol into a butanol distillation column. The overhead azeotrope is condensed with the butanol-rich liquid phase being returned to the butanol distillation column. The aqueous phase is passed to a water distillation column where a butanol-containing azeotrope is also condensed with the butanol-rich phase being passed to the butanol distillation column and the aqueous phase being passed to the water distillation column. The condensation and revaporization of the butanol and aqueous phases, especially with the volumes involved, require considerable energy consumption.

Typically, fermentation processes do not provide a single oxygenated organic compound. The metabolic pathways in a microorganism may result in more than one oxygenated organic compound being produced. For example, Clostridium acetobutylicum has been used to convert sugars to n-butanol with acetone and ethanol being co-products. Also, adventious microorganisms may contaminate the fermentation broth. For example, butyrogens may contaminate ethanol fermentation broths leading to the production of butanol or butyrates. Thus, the distillation unit operations in conventional commercial corn ethanol plants produce a fusel oil product. Another fermentation that can produce a plurality of oxygenated organic compounds is syntrophic fermentations where a first fermentation product is converted by another microorganism to another oxygenated organic compound.

Interests exist to recover as discrete, anhydrous products two or more oxygenated organic compounds from a fermentation broth containing oxygenated organic compounds that form azeotropes with water, and in some instances, azeotropes with other components in the fermentation broth. It is desired to provide processes for such recoveries of discrete oxygenated organic compounds that are energy efficient and do not require unduly complex integrated operations.

### SUMMARY OF THE INVENTION

By this invention processes are provided for separately recovering ethanol and at least one higher alcohol from an aqueous fermentation broth in an energy efficient manner. Both the ethanol and at least one higher alcohol form azeotropes with water, and the fermentation broth may contain other compounds that form binary and ternary azeotropes with water. In the processes, a vaporous, azeotropic mixture is obtained from the fermentation broth through fractionation by distillation and is maintained at a temperature sufficient to effect dehydration without condensation of ethanol and the at least one higher alcohol. The dehydrated mixture of alcohols is introduced into an alcohol recovery distillation assembly for fractionating to provide a dehydrated, ethanol-rich product and a dehydrated, higher alcohol-rich product. Accordingly, the processes of this invention achieve energy efficiency in that the alcohols are introduced into the alcohol recovery distillation assembly as a dehydrated, vapor phase thereby both avoiding energy losses associated with condensation and revaporization and retaining sensible heat in the vapor phase. Moreover, since the vapor phase is dehydrated, azeotropes including binary and ternary azeotropes of ethanol, the at least one higher alcohol and other components do not form, and thus recovery of discrete alcohol fractions is facilitated.

Thus, the broad aspects of this invention pertain to processes for separately recovering ethanol and at least one higher alcohol of 3 to 5 carbons from an aqueous fermentation broth comprising:
a. fractionating by distillation in a primary distillation assembly an aqueous fermentation broth containing ethanol and said at least one higher alcohol wherein the mass ratio of said at least one higher alcohol to ethanol is between about 1:20 to 20:1 to provide a vaporous, overhead fraction containing an azeotrope of ethanol and water and containing an azeotrope of the at least one higher alcohol and a bottoms fraction;
b. dehydrating said overhead fraction while maintaining said overhead fraction substantially in the vapor phase to provide vaporous, anhydrous, mixed alcohol; and
c. introducing at least a portion of said vaporous, anhydrous, mixed alcohol into an alcohol recovery distillation assembly and fractionating the mixed alcohol by distillation in said alcohol recovery distillation assembly to provide an ethanol-rich fraction and a discrete fraction comprising said at least one higher alcohol and being substantially free of ethanol.

Where the fermentation broth contains more than one higher alcohol, preferably the alcohol recovery distillation assembly comprises a secondary distillation column providing a first bottoms fraction that is passed to a tertiary distillation column that provides a first discrete fraction that is rich in the at least one higher alcohol and that has a lower boiling point and a second bottoms fraction is provided that contains the higher boiling alcohol having a boiling point that is higher than that of higher boiling alcohol of the first discrete fraction.

The dehydration may be effected in any suitable manner including, but not limited to, the use of solid desiccants and semipermeable membranes favoring the permeation of water as compared to alcohols. Where ethanol is the predominant oxygenated organic compound in the vaporous overhead fraction from the primary distillation assembly, e.g., at least about 80 volume percent based upon the total oxygenated organic compounds, the use of a desiccant is generally preferred. At lower concentrations of ethanol, the use of a vapor permeation unit using semipermeable membranes can be attractive, and in some instances, the membrane separation can be followed by the use of a desiccant. Frequently, the dehydrated, vaporous overhead fraction from the primary distillation assembly contains less than about 1, more preferably less than about 0.5, and in some instances less than about 0.1, volume percent water.

### BRIEF DESCRIPTION OF THE DRAWINGS

FIG. 1 is a schematic depiction of an apparatus suitable for practicing processes of this invention.

### DETAILED DISCUSSION

### Definitions

As used herein, the following terms have the meanings set forth below unless otherwise stated or clear from the context of their use.

The use of the terms “a” and “an” is intended to include one or more of the element described, and unless explicit or otherwise clear from the context, an element recited in the singular is intended to include one or more of such elements.

A discrete product is a distillation fraction containing an oxygenated organic compound which fraction is substantially anhydrous and has a concentration of the oxygenated organic compound that is at least about 80, preferably at least about 90, mass percent of that fraction.

A desiccant is a material, preferably a solid that selectively absorbs water. Examples of desiccants include, but are not limited to, silica, activated charcoal, activated alumina, starch, calcium sulfate, calcium chloride, and molecular sieves.

Fractionation by distillation and distillation includes any separation of mixtures of components based upon differences in volatility of the components such as rectification and distillation. A component may be a chemical compound or an azeotrope. A distillation assembly comprises one or more vessels, packing or trays (if used), overhead condenser and liquid recycle unit operations (if used), and reboiler. A distillation assembly may also include one or more additional unit operations as is known in the art. Distillation provides at least an overhead fraction rich in at least one component and a bottoms fraction rich in at least one other component. Side draw fractions may also be provided in a distillation. A fraction that is rich in a component means that the fraction contains a greater concentration than that in the feed to the distillation.

Oxygenated organic compound means one or more organic compounds containing two to six carbon atoms selected from the group of aliphatic carboxylic acids and salts, alkanols and alkoxide salts, and aldehydes.

Substantially vaporous means that no condensation of any component in a vapor stream occurs in an amount that results in a flowing liquid phase. Hence, it is possible that surfaces become wetted with a liquid phase but the overhead fraction remains substantially vaporous.

All patents, published and unpublished patent applications and articles referenced herein are hereby incorporated by reference in their entireties.

### Process

The processes of this invention pertain to recovering two or more alcohols from an aqueous fermentation broth. The fermentation unit operation is not critical to the broad processes of this invention provided that at least two alcohols are produced. The fermentation may be conducted using fermentable carbohydrates such as sugars and starches or syngas containing at least one of carbon monoxide and a mixture of hydrogen and carbon dioxide or carbon dioxide in photosynthetic fermentations. These types of fermentations are well known in the art. See, for instance, M. Vohra, et al., Bioethanol production: Feedstock and current technologies, J. Environ. Chem. Eng. (2013), doi.org/10.1016/j.jece.2013.10.013, and Berezina, et al., Microbial Producers of Butanol, Applied Biochemistry and Microbiology, doi: 10.1134/S0003683812070022 The fermentation may be continuous, batch or semi-continuous.

The concentration of alcohols in the fermentation broth and the presence of other metabolites will depend upon the nature of the fermentation broth including, but not limited to, the microorganism used, the substrate used and other fermentation conditions including, but not limited to, buffers and other additives, temperature. Generally the alcohols are present in a concentration of at least about 2 mass percent per liter of fermentation broth. The maximum concentration of alcohols in the fermentation broth is limited by, for example, the toxicity of the alcohols microorganisms and the available supply of substrate.

The aqueous fermentation broth contains ethanol and at least one higher molecular weight alcohol, and preferably the higher boiling alcohol has 5 or fewer carbon atoms. Examples of alcohols include ethanol, n-propanol, i-propanol, 1-butanol, 2-butanol, i-butanol, t-butanol, 1-pentanol, 2-pentanol, 3-pentanol, 3-methylbutan-1-ol, 2-methylbutan-ol, 3-methylbutan-2-ol, 2-methylpentan-2-ol, and 2,2-dimethylpropanol. The fermentation broth can contain other metabolites including, but not limited to acid and esters and other oxygenated organic compounds as might be produced by the microorganisms. The other metabolites can include metabolites that form binary or tertiary azeotropes with water and well as metabolites that form no azeotrope. In some fermentations, such as the fermentation of carbohydrates, carbon dioxide is co-produced. Biological processes to produce 1-butanol such as those using Clostridium acetobutylicum also produce acetone. Some strains of Clostridium beijerinckii are able to bioconvert acetone to isopropanol.

The at least one higher boiling alcohol to be recovered as a discrete product and ethanol are each present in appreciable quantities in the fermentation broth, and thus are material contributors or their azeotropes are material contributors to the vapor-liquid equilibria of the fermentation broth. The mass ratio of the at least one higher alcohol to be recovered (total of all higher alcohols to be recovered) as discrete products to ethanol in the fermentation broth is between about 1:20 to 20:1, and in some instances, this mass ratio is in the range of about 1:10 to 10:1. Where more than one higher boiling alcohol is sought to be recovered as a discrete product, the mass ratio between the higher boiling alcohols is typically in the range of between 1:10 to 10:1. In most instances, some higher alcohols and other metabolites in the fermentation broth will not be recovered as discrete products. The preferred discrete products to be produced by the processes of this invention are ethanol and at least one of n-propanol, i-propanol, 1-butanol, 2-butanol and i-butanol.

In the primary distillation assembly the fermentation broth is fractionated by distillation to provide an overhead fraction containing azeotropes of at least ethanol and the at least one higher boiling alcohol to be recovered as a discrete product. The azeotropes of ethanol and higher boiling alcohols have normal boiling points below water thus enabling fractionation. As some higher boiling alcohols have normal boiling points above that of water such as 1-butanol, the formation of the lower boiling point azeotropes facilitates their fractionation from water. The primary fractionation can be conducted with any suitable distillation assembly using suitable distillation conditions. The specific conditions will depend on the design of the distillation assembly and the nature of the azeotropes to be separated from the fermentation broth. The fractionation may occur at subatmospheric, atmospheric or above atmospheric pressure. Hence, the bottom temperature and the head temperature can fall within a broad range. Typically, the distillation assembly contains sufficient theoretical plates to enable the sought separation of water and azeotropes to be achieved. Also, the distillation assembly may be designed such that solid debris in the fermentation broth is removed with the bottoms stream.

The overhead fraction may be a substantially azeotropic, i.e., little, if any, water is contained in the overhead fraction other than that associated with the azeotropes. For instance, the overhead fraction frequently contains less than about 5, preferably less than about 2, or even less than 1, volume percent water other than that associated with azeotropes based upon the withdrawn overhead fraction. In accordance with the processes of this invention, the overhead fraction from the primary distillation assembly is dehydrated and the overhead fraction is maintained in the vapor phase during the dehydration. Especially in situations where the breaking of the azeotrope results in the formation of a component that has a boiling point higher than that of water, it may be necessary to increase the temperature of the overhead fraction to avoid condensation of that component. Similarly, if it is desired to increase the pressure of the overhead fraction to facilitate dehydration, a temperature increase is often required to avoid condensation of a component. The heating of the overhead fraction may occur before or during the dehydration unit operations.

As discussed above, the dehydration may be conducted by any suitable unit operation or operations, including, but not limited to, the use of desiccants and membrane separations. The preferred desiccants are those which are capable of being regenerated, e.g., by heating and/or reducing pressure to remove water. Hence, the selection of these desiccants is generally based upon the ability of the desiccant to break the azeotropes and dehydrate the overhead fraction at a temperature at which the overhead fraction is maintained in a vaporous form using an economically viable amount of desiccant at reasonable cycle times. Molecular sieves which include zeolites and non-zeolites, especially molecular sieves having an effective pore diameter of between about 3 and 4 Angstroms such as 3A molecular sieves, are most preferred.

Membrane separations involve the contact of the overhead fraction with membranes selectively permeable by water. A driving force, typically a partial pressure differential, is maintained across the membrane to effect the permeation of water. Preferably the membrane separation is a pervaporation where the water leaves the membrane as a vapor. The partial pressure driving force can be obtained by one or more of providing the overhead fraction at an above atmospheric pressure and maintaining the permeate side of the membrane at subatmospheric pressure. Where the pressure of the overhead fraction is increased, the temperature of the overhead fraction should also be increased to avoid condensation. Frequently the pressure of the overhead fraction is in the range of about 150 to 1000 kPa absolute. The permeate side of the membrane is often in the range of between about 10 and 120 kPa absolute such that a differential in pressure across the membrane is in the range of about 50 to 1000, say, 100 to 500, kPa. Although the configuration of the membrane is not critical to the broad aspects of this invention, membrane separation assemblies typically use hollow fiber membranes or spiral wound membranes. The membrane may be of any suitable material. Examples of suitable membranes are disclosed in U.S. Pat. Nos. 7,556,677; 8,002,874; and 8,496,831. Especially where the azeotrope of the at least one higher boiling alcohol has a substantial water content, a combination of membrane separation followed by the use of a desiccant to remove water is particularly useful when the driving force for the membrane permeation diminishes.

The dehydrated overhead fraction is then fractionated by distillation in an alcohol recovery distillation assembly to provide the discrete ethanol product and a discrete product containing a higher boiling alcohol. This assembly may contain one or more distillation columns, the first being referred to herein as a secondary distillation column or assembly. The next column in fluid flow is referred to as a tertiary distillation column or assembly. Further distillation columns or assemblies can be used, particularly where more than one higher boiling alcohol is sought to be obtained as a discrete product. Any suitable distillation unit operation or operations can be used in the alcohol recovery distillation assembly. The specific design and distillation conditions will be determined by the higher boiling alcohol or alcohols to be obtained as discrete products. Typically distillation columns having a plurality of theoretical plates are used, e.g., as provided by packing or trays.

The overhead fraction from the primary distillation assembly is introduced into the alcohol recovery distillation assembly as a vaporous feed. Thus, the vaporous feed provides both sensible and latent heat to the alcohol recovery distillation assembly and enhances energy efficiency as compared to using a condensed liquid feed. In the event that the overhead fraction from the primary distillation assembly was heated, the processes of this invention would thus allow recovery of at least a portion of the heat. It should also be noted that the depicted apparatus permits flexibility in operation. For instance, if little higher boiling alcohol is in the fermentation broth, the secondary distillation assembly need not be operated and a single product stream containing ethanol is produced.

In one optional mode of operation, a discrete ethanol product is obtained and at least one other discrete product is obtained from the distillation, but other components, which may include other higher boiling alcohols and esters, that are not intended to be discrete products, are recovered and mixed with the ethanol product where the ethanol product is intended for use as a fuel additive.

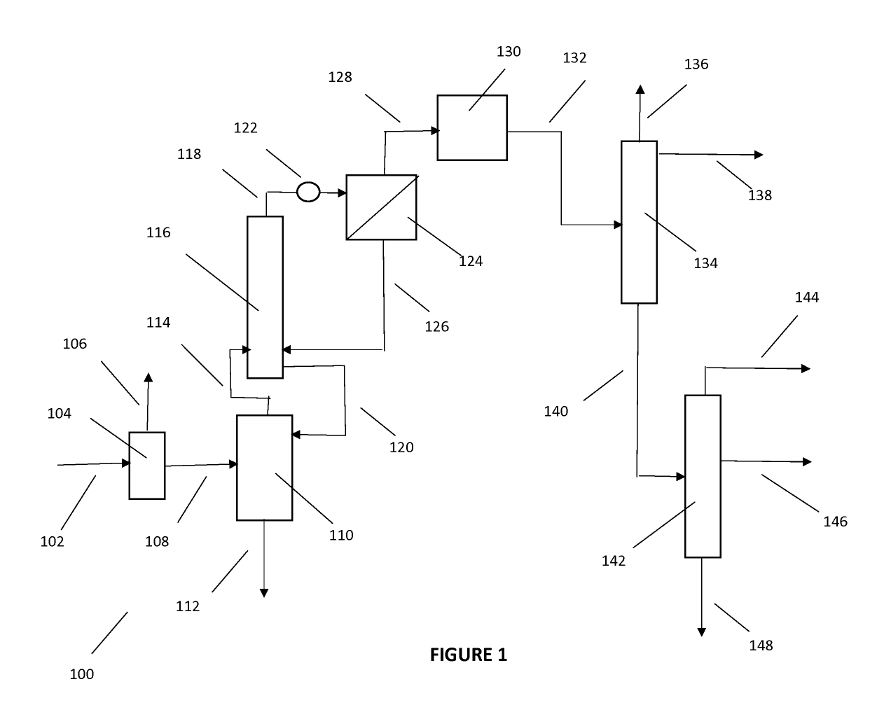

The invention will be further described by reference to FIG. 1 which is a schematic depiction of apparatus useful for conducting the processes of this invention. Depiction of the invention in schematic form is not intended to limit the invention to the detail and components illustrated therein which are provided for purposes of exemplification and are not in limitation.

FIG. 1 is a schematic depiction of an apparatus generally designated as 100. FIG. 1 omits minor equipment such as pumps, compressors, valves, instruments and other devices the placement of which and operation thereof are well known to those practiced in chemical engineering. FIG. 1 also omits ancillary unit operations. The process and operation of FIG. 1 will be described in the context of the recovery and production of an ethanol and 1-butanol-containing fermentation broth containing a mass ratio of butanol to ethanol to acetone of 6:1:3. The fermentation broth is derived from the fermentation of syngas using Clostridium acetobutylicum and contains about 2.5 mass percent 1-butanol. The fermentation broth contains minor amounts of other components including isopropanol, 2-butanol, i-butanol and alcohols having 5 or more carbons and esters of acetate and butyrate.

A fermentation broth is passed via line 102 to vapor separator 104 at approximately the temperature of the fermentation, i.e., about 37° C. Higher and lower temperatures can be use, e.g., in the range of about 5° to 120° C., and the pressure can range from about 5 to 500 kPa absolute. Normally gaseous components such as hydrogen, carbon monoxide, carbon dioxide, methane and nitrogen that are undissolved in the fermentation broth are withdrawn via line 106. Due to its low boiling point, some of the acetone also is evaporated and exits with the gases. Where the fermentation broth involves the bioconversion of a carbohydrate, carbon dioxide is generated and will be the primary gas withdrawn via line 106. The use of a vapor separator is optional.

A degassed fermentation broth is withdrawn from vapor separator and is passed via line 108 to a primary distillation assembly. As depicted, the primary distillation assembly has two distillation stages, a first stage 110 and a second stage 116. First stage 110 is operated to separate solids and high boiling liquids in an aqueous bottoms fraction. The bottoms stream can contain acids and esters as well as debris from the fermentation. The bottoms temperature is sufficiently high and the residence time is sufficiently long that the microorganisms are killed. The bottoms temperature is often about 100° to 120° C. The bottoms fraction exits via line 112. An overhead fraction from first stage 110 is passed via line 114 to second stage 116 which, for purposes of discussion, is a distillation column containing distillation trays. The overhead fraction from first stage 110 contains acetone, ethanol, butanol and water. The second stage 116 of the distillation assembly provides a vaporous, azeotrope-containing overhead fraction which exits via line 118. Line 118 only receives a portion of the overhead fraction and the remaining portion is condensed and returned to the top of second stage 116 as reflux (not shown). A bottoms fraction from second stage 116, which is primarily water, is shown as being returned to first stage 110 via line 120.

The overhead fraction in line 118 is heated by indirect heat exchanger 122 and passed to membrane separation assembly 124. The temperature of the overhead fraction is raised sufficiently by heat exchanger 122 such that essentially no condensates are formed from the overhead fraction during dehydration. Often the temperature of the vaporous overhead fraction is in the range of 110° C. to 150° C. Membrane separation assembly 124 is a pervaporation assembly containing hollow fiber membranes. The membrane separation assembly raises the pressure of the vaporous overhead fraction to about 200 kPa gauge, and the permeate side of the membranes is maintained under vacuum (about 50 kPa absolute). A water vapor-containing permeate is passed via line 126 to second stage 116. The retentate, which contains about 3 to 5 volume percent water, is passed via line 128 to molecular sieve drier assembly 130 where the water concentration is reduced to less than about 0.5 volume percent. Molecular sieve drier assembly 130 is also adapted to regenerate the desiccant, e.g., by a swing operation where one bed is being regenerated while others remain on-line.

As depicted, the dehydrated, vaporous overhead fraction in line 132 is introduced into secondary distillation assembly 134. Line 136 allows a vapor phase overhead fraction to exit assembly 134. This vaporous overhead contains acetone. A condensed ethanol product exits via line 138 and is a discrete product containing substantially 99.5 mass percent ethanol. The bottoms fraction from secondary distillation assembly 134 is withdrawn via line 140 and passed to tertiary distillation assembly 142. This bottoms fraction contains higher boiling alcohols and is substantially devoid of ethanol. Tertiary distillation assembly provides an overhead fraction withdrawn via line 144. This overhead is a discrete product and contains isopropanol. A side draw exits via line 146 and contains components having normal boiling points between about 85° and 110° C. A bottoms fraction is withdrawn via line 148 and is a discrete product comprising about 99 mass percent 1-butanol.

The preamble to any claim in this invention is part of the entire claim and applies to interpreting the scope and coverage of each claim.

It is claimed:

1. A process for separately recovering ethanol and at least one higher alcohol of 3 to 5 carbons from an aqueous fermentation broth comprising:
a. fractionating by distillation in a primary distillation assembly an aqueous fermentation broth containing ethanol and said at least one higher alcohol wherein the mass ratio of said at least one higher alcohol to ethanol is between about 1:20 to 20:1 to provide a vaporous, overhead fraction containing an azeotrope of ethanol and water and containing an azeotrope of the at least one higher alcohol and a bottoms fraction;
b. dehydrating said overhead fraction while maintaining said overhead fraction substantially in the vapor phase to provide vaporous, anhydrous, mixed alcohol; and
c. introducing at least a portion of said vaporous, anhydrous, mixed alcohol into an alcohol recovery distillation assembly and fractionating by distillation in said alcohol recovery distillation assembly to provide an ethanol-rich fraction and a discrete fraction comprising said at least one higher alcohol and being substantially free of ethanol.

2. The process of claim 1 wherein the vaporous, overhead fraction contains less than about 2 volume percent water other than that associated with azeotropes.

3. The process of claim 1 wherein the dehydration of step b is effected, at least in part, by a desiccant.

4. The process of claim 3 wherein the desiccant comprises molecular sieve.

5. The process of claim 1 wherein the dehydration of step b is effected, at least in part, by membrane separation.

6. The process of claim 5 wherein the membrane separation is a pervaporation and a retentate is provided containing an at least partially dehydrated overhead fraction.

7. The process of claim 6 wherein the retentate is further dehydrated using a desiccant.

8. The process of claim 1 wherein the dehydrated vaporous overhead fraction of step b contains less than 0.5 volume percent water.

9. The process of claim 1 wherein at least two higher boiling alcohols are recovered as discrete products.

10. The process of claim 9 wherein the alcohol recovery distillation assembly comprises a secondary distillation column and a tertiary distillation column, and a discrete ethanol product is obtained from the secondary distillation column.

11. The process of claim 1 wherein the fermentation broth comprises ethanol and 1-butanol and butanol is recovered as a discrete product in step c.

12. The process of claim 11 wherein the fermentation broth also comprises acetone and an acetone fraction is obtained from the alcohol recovery distillation assembly.

13. The process of claim 1 wherein the higher boiling alcohol comprises one or more of n-propanol, i-propanol, 1-butanol, 2-butanol and i-butanol.

14. The process of claim 13 wherein the overhead fraction from the primary distillation assembly contains at least two higher boiling alcohols, and at least one higher boiling alcohol is recovered as a discrete product and at least one other higher boiling alcohol is mixed with the ethanol rich fraction.

15. The process of claim 1 wherein the fermentation broth also comprises undissolved, normally gaseous components and the process separates the normally gaseous components from the fermentation broth prior to being introduced into the primary distillation assembly.

16. The process of claim 15 wherein the normally gaseous components comprise one or more of hydrogen, carbon monoxide, carbon dioxide, nitrogen and methane.

17. A process for separately recovering ethanol and i-butanol from an aqueous fermentation broth comprising ethanol and i-butanol and containing one or more of hydrogen, carbon monoxide, carbon dioxide, nitrogen and methane, the process comprising:
a. separating at least a portion of the normally gaseous components from the fermentation broth to produce a gas depleted fermentation broth;
a. fractionating by distillation in a primary distillation assembly the gas depleted fermentation broth containing ethanol and i-butanol wherein the mass ratio of butanol to ethanol is between about 1:20 to 20:1 to provide a vaporous, overhead fraction containing an azeotrope of ethanol and water and containing an azeotrope of i-butanol and a bottoms fraction;
b. dehydrating said overhead fraction while maintaining said overhead fraction substantially in the vapor phase to provide vaporous, ethanol and butanol containing less than 5 volume % water; and
c. introducing at least a portion of said vaporous, anhydrous, ethanol and butanol into an alcohol recovery distillation assembly and fractionating by distillation in said alcohol recovery distillation assembly to provide an ethanol-rich fraction and an isobutanol fraction being substantially free of ethanol.

18. The process of claim 17 wherein the dehydration of step b is effected, at least in part, by a: desiccant; a desiccant comprising a molecular sieve; a membrane separation; a membrane separation comprising ; or a membrane separation comprising a pervaporation wherein a retentate is provided containing an at least partially dehydrated overhead fraction.

19. The process of claim 18 wherein the retentate is further dehydrated using a desiccant.

20. The process of claim 17 wherein the alcohol recovery distillation assembly comprises a secondary distillation column and a tertiary distillation column, and a discrete ethanol product is obtained from the secondary distillation column.
